(19) United States
(12) Patent Application Publication
(10) Pub. No.: US 2007/0070955 A1
(43) Pub. Date: Mar. 29, 2007

(54) Reverse data rate controlling method in mobile communication system

(76) Inventor: Jee Woong Seol, Gyeonggi-do (KR)

Correspondence Address: FLESHNER & KIM, LLP, P.O. BOX 221200, CHANTILLY, VA, 20153, US

(21) Appl. No.: 10/580,246

(22) PCT Filed: Dec. 3, 2004
(86) PCT No.: PCT/KR04/03175

§ 371 Date: May 22, 2006

(30) Foreign Application Priority Data
Dec. 5, 2003 (KR) 10-2003-0088263

(51) Int. Cl. H04B 7/216

(52) U.S. Cl. 370/335

(57) ABSTRACT

The present invention provides a method of controlling a reverse data rate in a mobile communication system. In controlling a reverse data rate by a mobile station of a mobile communication system supporting a H-ARQ system, the present invention includes the steps of receiving a grant message including reverse data rate control information and application range indication information from a base station and controlling the reverse data rate according to the reverse data rate control information included in the grant message, wherein if the application range indication information indicates that contents of the grant message are applied to a corresponding ARQ-channel at a moment of receiving the grant message only, an application range of the contents of the grant message is limited to a prescribed range even if receiving a NAK signal from the base station at a time point of receiving the grant message. Preferably, the prescribed range is an ARQ-channel unit group.

### TECHNICAL FIELD

The present invention relates to a method of controlling a reverse data rate in a mobile communication system, and more particularly, to a method of controlling a reverse data rate, by which unnecessary interference occurrence in a system using scheduling as a data rate control method of a reverse channel is minimized in a manner of enabling a base station to prevent data on an unexpected range from being transmitted over the reverse channel.

### BACKGROUND ART

The standard cdma 2000 revision D of synchronous CDMA will be completed in fall, 2003. The most distinguishable feature of the revision D lies in that 1.5 Mbps transmission is enabled using a reverse packet data channel (R-PDCH). To support such an R-PDCH, there exist F-ACKCH (forward acknowledgement channel), R-PDCCH (reverse packet data control channel), F-RCCH (forward rate control channel), R-REQCH (reverse request channel), F-GCH (forward grant channel), and the like in a system.

A mobile station is not allowed to determine an R-PDCH transmission data rate arbitrarily. If a specific mobile station uses a high data rate, serious interference influence is caused to a relative side to make a system unstable. To overcome such a problem, a base station adjusts a reverse data rate of the mobile station by considering a sate of the mobile station, a status of a reverse link channel, and the like.

According to a form that a base station notifies information to a mobile station, there are a rate control method and a scheduling method. In the rate control method, a transmission data rate is determined in a manner of inferring it from a previous data rate using the small number of information bits. In the scheduling method, a base station can determine a transmission data rate independently each moment via a grant message. Currently, control algorithm mixed with the rate control and scheduling methods is adopted as a data rate determining method of a reverse channel by the 3GPP2 conference.

According to the above algorithm, F-GCH and F-RCCH are assigned to a mobile station through a call negotiation with a base station. And, the mobile station informs the base station of its state information such as buffer size, transmission power state, QoS class, etc. via R-REQCH (reverse request channel). The base station then transmits a grant message via F-GCH or data rate control information via F-RCCH to control a data rate of R-PDCH.

The mobile station uses authorized_TPR to determine the data rate. A value of the authorized_TPR is allocated to the mobile station by the base station. And, the mobile station can determine the data rate only within a range not exceeding the value. The authorized_TPR is a value that means a traffic to pilot ratio of R-PDCH and includes TPR per encoder packet size. Moreover, one encoder packet size is mapped to one data rate.

The grant message of F-GCH contains a MAX_MAC_SDU_SIZE value that means an encoder packet size indicator, which will be explained later. Hence, the mobile station recognizes the authorized_TPR according to the value.

In case that the mobile station receives data rate control information (data rate control bit, hereinafter abbreviated RCB) via F-RCCH, the authorized_TPR is determined in a following manner. First of all, RCB transmitted over F-RCCH contains information of HOLD, UP, or DOWN. And, the mobile station computes the authorized_TPR as follows.

authorized_TPR=authorized_TPR+UP_step (RCB has a meaning of UP)

authorized_TPR=authorized_TPR+DOWN_step (RCB has a meaning of DOWN)

authorized_TPR=authorized_TPR (RCB has a meaning of HOLD)

FIG. 1 is a diagram for explaining a method of controlling a data rate of each packet of R-PDCH via F-RCCH based on a reverse data rate allocated via F-GCH, and FIG. 2 is a diagram for explaining a method of controlling a data rate via F-GCH.

The cdma 2000-release D provides a hybrid-automatic repeat request (H-ARQ) system. In the H-ARQ system, a base station informs a mobile station whether a transmitted packet is correctly received (ACK) or not correctly received (NAK). The mobile station then carries out retransmission of the packet corresponding to transmission failure without waiting for an instruction of an upper layer. Yet, the current draft CDMA standard puts limitation on the retransmission number to prevent the packet from being consecutively retransmitted.

In the system supporting H-ARQ, retransmission of a packet of R-PDCH is carried out based on ACK/NAK information of F-ACKCH (forward acknowledgment channel). In doing so, a multitude of ARQ-channels can be formed in one channel by an ACK delay. This is because a data rate of R=PDCH is controlled via F-RCCH or F-GCH at the same time of F-ACKCH. Hence, a multitude of the ARQ-channels can control data rates independently by the rate control method or the scheduling method. The ARQ-channel means not a physical channel but a time-division logic channel.

FIG. 3 is a diagram of four ARQ-channels formed in one channel, in which each ARQ-channel is identified by ACID. A success or failure of a packet transmitted via R-PDCH can be known after an ACK delay. Hence, it is able to configure independent ARQ-channels until a time point of applying ACK information. In the description of the present invention, as shown in FIG. 3, an ARQ-channel of ACID=0 to an ARQ-channel of ACID=3 prior to a next ARQ-channel of ACID=0 are defined as an ARQ-channel unit group to be used in the following. Yet, a beginning of the ARQ-channel unit group can start not only ACID=0 but also any one of ACID=1, ACID=2, and ACID=3. And, the ARQ-channel unit group indicates four ARQ-channels regardless of a beginning point.

A data rate of a packet transmitted via R-PDCH should be sustained in case of retransmission attributed to a packet transmission failure. Namely, a variation of the data rate is applicable in case of transmitting a new packet.

A grant message of F-GCH includes the following information.

MAC_ID: MAC indicator. This is used in designating a specific mobile station as well as in designating entire mobile stations, e.g., MAC_ID=0.

MAX_MAC_SDU_SIZE: a maximum encoder packet size that is allocated. Namely, it means a maximum data rate.

ALL_ACID_IND: an indicator informing whether the grant message of F-GCH is applied to the entire ARQ-channel unit group.

PERSISTENCE: an indicator informing whether the grant message of F-GCH keeps being applied to a specific ARQ-channel.

If a value of ALL_ACID_IND included in the grant message transmitted via F-GCH is TRUE, the contents of the grant message of F-GCH are applied to the entire ARQ-channel unit group from the moment of receiving the grant message. If the value of ALL_ACID_IND is FALSE, the contents of the grant message of F-GCH are applied to a specific one of the ARQ-channels at the moment of receiving the grant message.

If a value of PERSISTENCE included in the grant message transmitted via F-GCH is TRUE, the contents of the grant message of F-GCH keep being applied to the corresponding ARQ-channel from the moment of receiving the grant message. If the value of PERSISTENCE included in the grant message is FALSE, the contents of the grant message are applied to the corresponding ARQ-channel at the moment of receiving the grant message only and are then lowered to an autonomous data rate thereafter.

Hence, a range of application of the grant message is determined as four types according to the values of ALL_ACID_IND and PERSISTENCE.

FIG. 4 is a diagram for explaining a case that a mobile station having received an ACK signal determines a data rate of a new packet according to a grant message. In FIG. 4, since each value of ALL_ACID_IND and PERSISTENCE included in the grant message is FALSE, the contents of the grant message are applied only if ACID=0 at the moment of receiving the grant message. Hence, a mobile station determines a data rate according to a value of MAX_MAC_SDU_SIZE included in the grant message. A new packet then returns to an autonomous data rate to the transmitted.

FIG. 5 is a diagram for explaining a case that a mobile station receives a NAK signal via an ARQ-channel of ACID=0, performs retransmission of a previous packet, and then determines a data rate by applying a grant message in case of receiving an ACK signal. Since each value of ALL_ACID_IND and PERSISTENCE included in the grant message is FALSE, the contents of the grant message should be applied to the ARQ-channel of ACID=0 at the moment of receiving the grant message. Yet, since the mobile station has received the NAK signal, a packet is retransmitted at a previous data rate at the ARQ-channel of ACID=0 at the moment. And, the mobile station determines a data rate according to a value of MAX_MAC_SDU_SIZE included in the previously received grant message in the ARQ-channel of ACID=0 after the mobile station has received the ACK signal.

FIG. 6 is a diagram for explaining a method of determining a data rate by a mobile station in case that values of ALL_ACID_IND and PERSISTENCE included in a grant message are TRUE and FALSE, respectively. If the values of ALL_ACID_IND and PERSISTENCE included in the grant message are TRUE and FALSE, respectively, the contents of the grant message are applied only within the ARQ-channel unit group of ACID=0, ACID=1, ACID=2, and ACID=3 at the moment that the mobile station receives the grant message. Yet, a packet is retransmitted at a previous data rate in the ARQ-channels of ACID=0 and ACID=2 where the mobile station has received a NAK signal. If receiving an ACK signal in the ARQ-channels of ACID=0 and ACID=2 later, the mobile station determines a data rate according to a value of MAX_MAC_SDU_SIZE included in the previously received grant message.

If the PERSISTENCE vale is FALSE, it means that a resource is allocated to the mobile station at a specific moment only. Yet, in case that the mobile station, as shown in FIG. 5 or FIG. 6, having received the NAK signal to need the packet retransmission, the base station is unable to predict when the packet will end. Namely, with reference to FIG. 5 or FIG. 6, the data rate may be determined according to the MAX_MAC_SDU_SIZE value included in the previous grant message after 4-frames from the time point of receiving the grant message. This is not predicted by the base station, whereby unnecessary interference is caused to the system.

### DISCLOSURE OF THE INVENTION

Accordingly, the present invention is directed to a method of controlling a reverse data rate in a mobile communication system that substantially obviate one or more of the problems due to limitations and disadvantages of the related art.

An object of the present invention is to provide a method of controlling a reverse data rate, by which unnecessary interference occurrence in a system using a scheduling method or both a scheduling method and a data rate method as a data rate control method of a reverse channel is minimized in a manner of enabling a base station to prevent data on an unexpected range from being transmitted over the reverse channel.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in controlling a reverse data rate by a mobile station of a mobile communication system supporting a H-ARQ system, a reverse data rate control method according to the present invention includes the steps of receiving a grant message including reverse data rate control information and application range indication information from a base station and controlling the reverse data rate according to the reverse data rate control information included in the grant message, wherein if the application range indication information indicates that contents of the grant message are applied to a corresponding ARQ-channel at a moment of receiving the grant message only, an application range of the contents of the grant message is limited to a prescribed range even if receiving a NAK signal from the base station at a time point of receiving the grant message. Preferably, the prescribed range is an ARQ-channel unit group.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram for explaining a method of controlling a data rate of each packet of R-PDCH via F-RCCH based on a reverse data rate allocated via F-GCH;

FIG. 2 is a diagram for explaining a method of controlling a data rate via F-GCH;

FIG. 3 is a diagram of four ARQ-channels formed in one channel;

FIG. 4 is a diagram for explaining a case that a mobile station having received an ACK signal determines a data rate of a new packet according to a grant message;

FIG. 5 is a diagram for explaining a case that a mobile station receives a NAK signal via an ARQ-channel of ACID=0, performs retransmission of a previous packet, and then determines a data rate by applying a grant message in case of receiving an ACK signal;

FIG. 6 is a diagram for explaining a method of determining a data rate by a mobile station in case that values of ALL_ACID_IND and PERSISTENCE included in a grant message are TRUE and FALSE, respectively;

FIG. 7a is a diagram of an application range of a grant message received by a mobile station in case that each value of ALL_ACID_IND and PERSISTENCE included in the grant message is FALSE;

FIG. 7b is a diagram of an application range of a grant message received by a mobile station in case that values of ALL_ACID_IND and PERSISTENCE included in the grant message are TRUE and FALSE, respectively; and

FIG. 8 and FIG. 9 are diagrams for explaining one preferred embodiment according to the present invention.

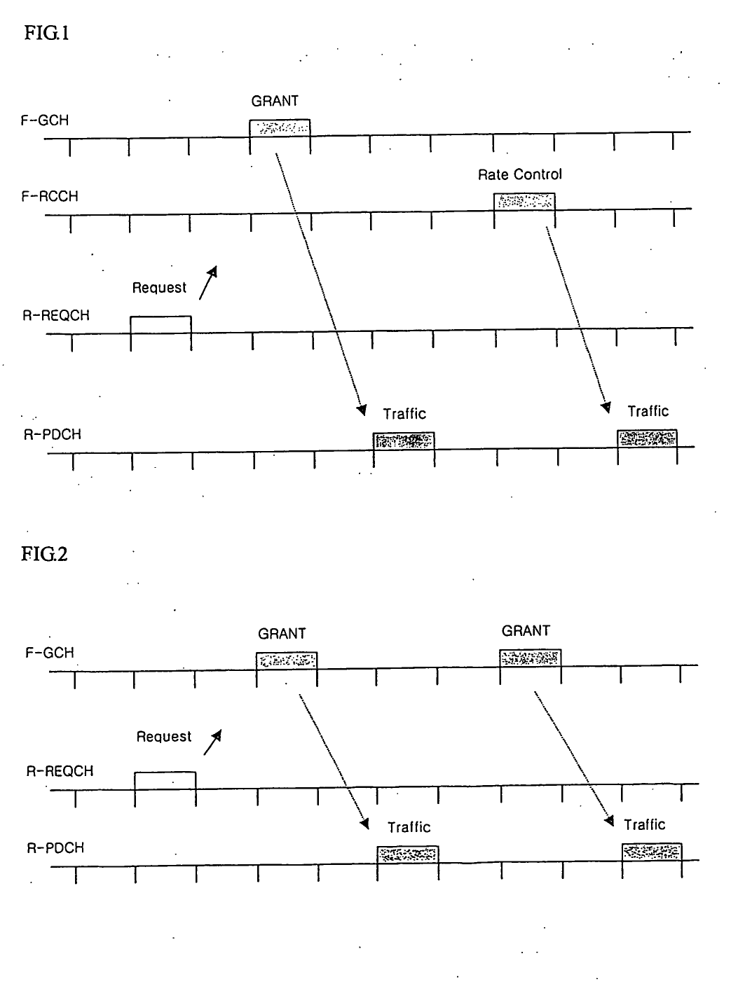

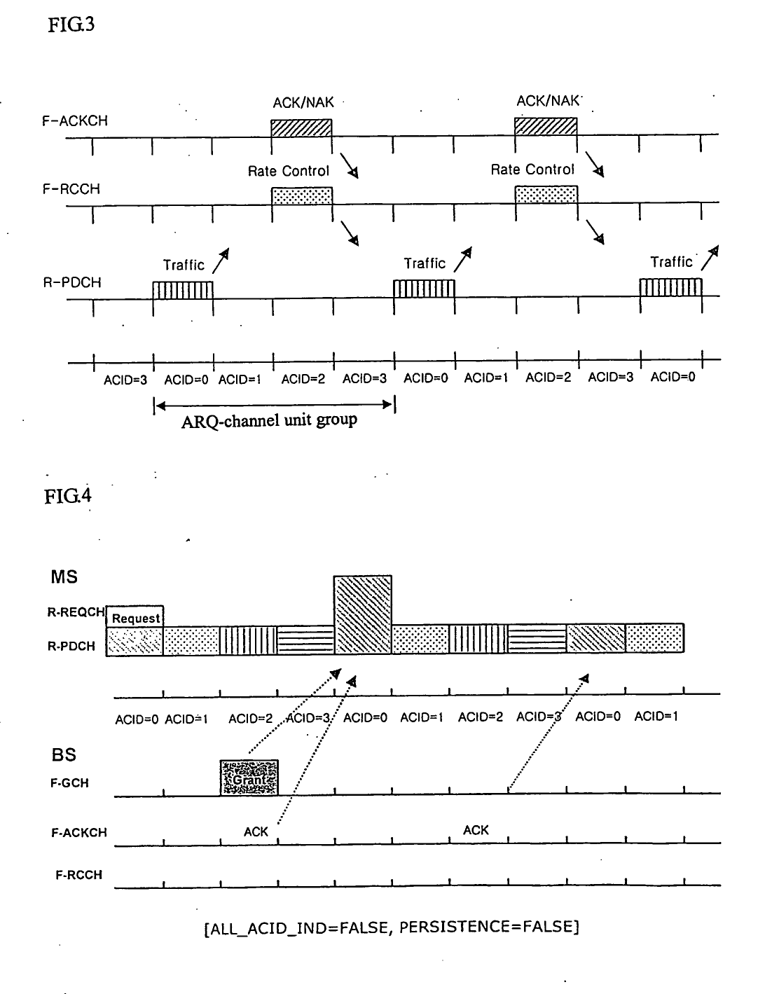

### BEST MODE FOR CARRYING OUT THE INVENTION

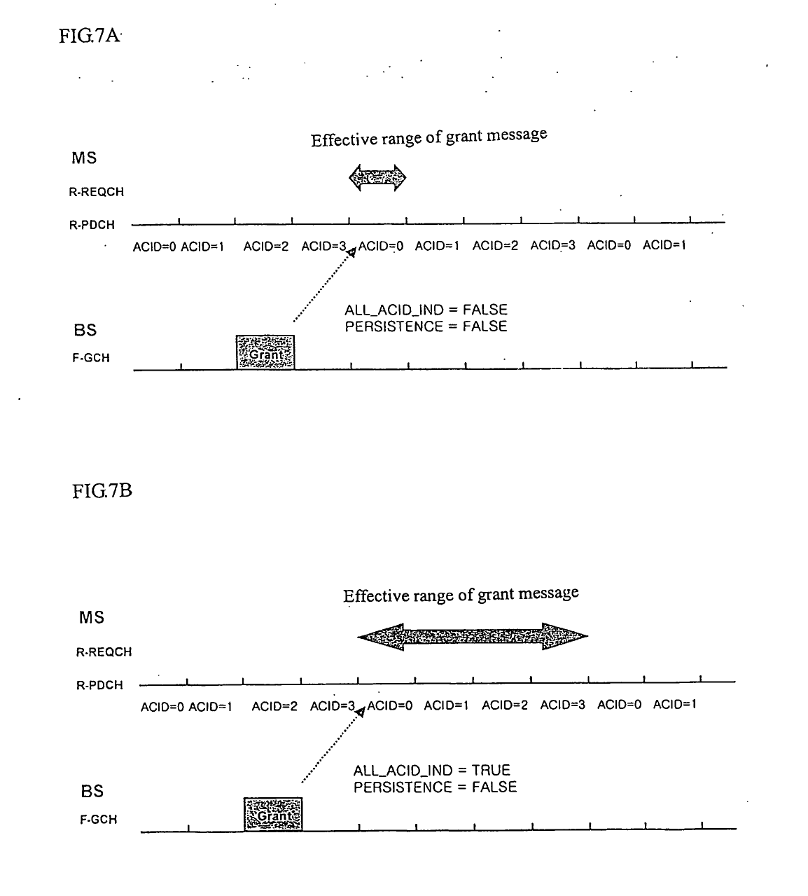

Reference will now be made in detail to the preferred embodiments of the present invention, examples of which are illustrated in the accompanying drawings, FIGS. 7a to 9.

First of all, if a PERSISTENCE value included in a grant message received by a mobile station is TRUE, the mobile station determines a reverse data rate in the same manner of the related art. Yet, the present invention is characterized in that an application range of a grant message is different from that of the related art if a PERSISTENCE value is FALSE.

FIG. 7a is a diagram of an application range of a grant message received by a mobile station in case that each value of ALL_ACID_IND and PERSISTENCE included in the grant message is FALSE. In this case, an application range of a grant message is limited to a corresponding ARQ-channel within an ARQ-channel unit group only.

FIG. 7b is a diagram of an application range of a grant message received by a mobile station in case that values of ALL_ACID_IND and PERSISTENCE included in the grant message are TRUE and FALSE, respectively. In this case, an application range of a grant message corresponds to an ARQ-channel unit group.

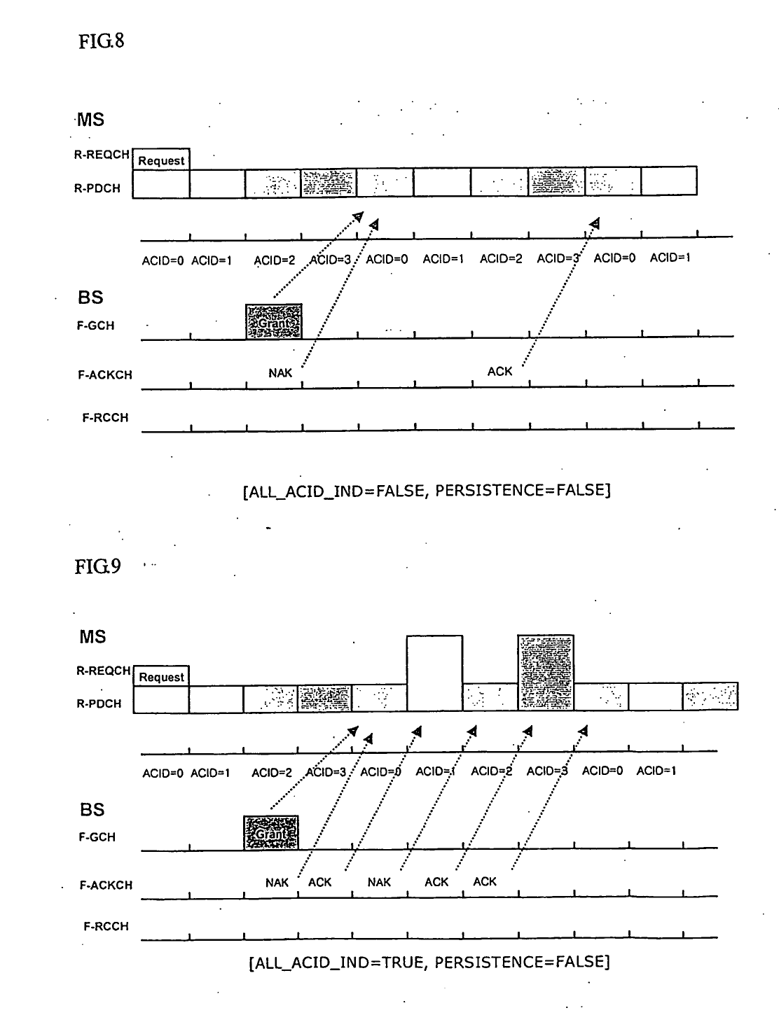

The present invention will be explained in detail with reference to FIG. 8 and FIG. 9 as follows. FIG. 8 shows a case that each value of ALL_ACID_IND and PERSISTENCE included in a grant message is FALSE. In case of receiving a NAK signal from a base station over an ARQ-channel of ACID=0, a mobile station should retransmit a packet at a previous data rate regardless of the received grant message. In case of receiving an ACK signal over a next ARQ-channel of ACID=0, the mobile station determines a reverse data rate according to a new grant message or command contents of RCB in a manner of putting limitation on an application range of the grant message instead of following the contents of the previously received grant message. For reference, in the related art method, the data rate was determined according to the contents of the previously received grant message (cf. FIG. 5).

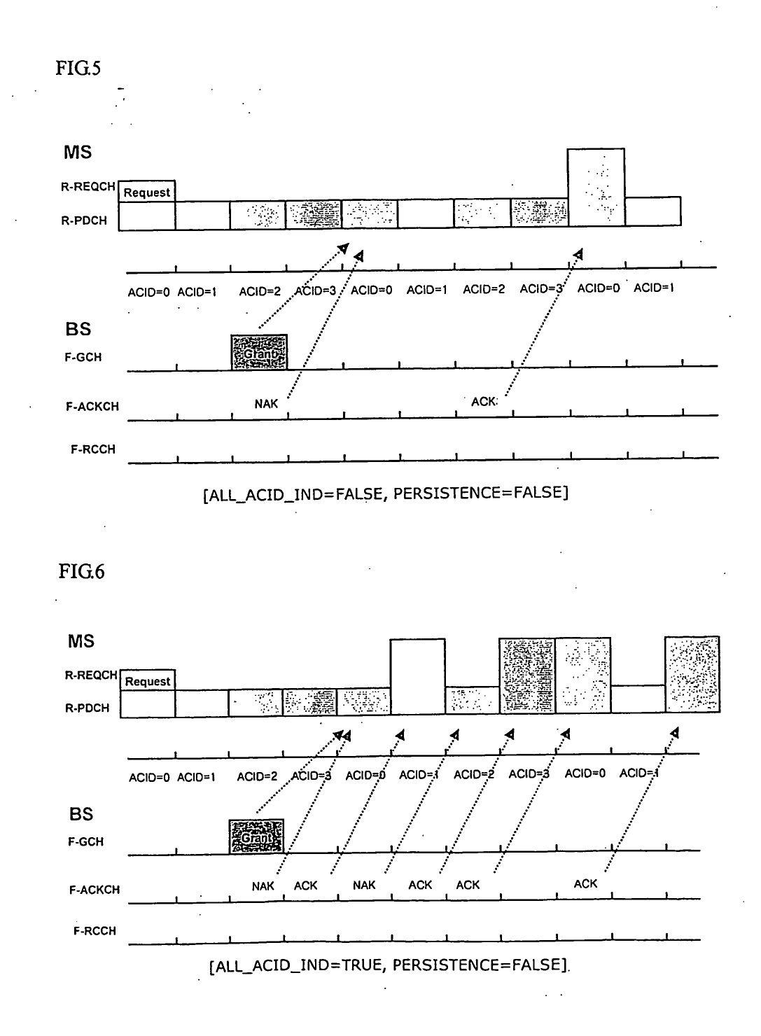

FIG. 9 shows a case that values of ALL_ACID_IND and PERSISTENCE included in a grant message are TRUE and FALSE, respectively. In case of receiving NAK signals from a base station over ARQ-channels of ACIID=0 and ACID=2, a mobile station should retransmit a packet at a previous data rate regardless of the received grant message. In case of receiving ACK signals over next ARQ-channels of ACID=0 and ACID=2, the mobile station determines a reverse data rate according to a new grant message or command contents of RCB in a manner of putting limitation on an application range of the grant message instead of following the contents of the previously received grant message. For reference, in the related art method, the data rate was determined according to the contents of the previously received grant message (cf FIG. 6). Hence, the base station can predict the reverse data rate accurately to prevent unnecessary interference from occurring in the system.

### INDUSTRIAL APPLICABILITY

Accordingly, in the reverse data rate control method in the mobile communication system according to the present invention, by limiting the application range of the grant message in case of ‘PERSISTENCE=FALSE’, the application time point is not affected by the NAK signal received by the mobile station. Hence, the base station can efficiently manage the reverse resources to avoid the related art unpredictable interference occurrence. Therefore, the present invention raises capacity of the mobile communication system and stabilizes the system.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. In controlling a reverse data rate by a mobile station of a mobile communication system supporting a H-ARQ system, a reverse data rate control method comprising the steps of:
receiving a grant message including reverse data rate control information and application range indication information from a base station; and
controlling the reverse data rate according to the reverse data rate control information included in the grant message,
wherein if the application range indication information indicates that contents of the grant message are applied to a corresponding ARQ-channel at a moment of receiving the grant message only, an application range of the contents of the grant message is limited to a prescribed range even if receiving a NAK signal from the base station at a time point of receiving the grant message.

2. The reverse data rate control method of claim 1, wherein the reverse data rate control information is a maximum encoder packet size (EP-SIE).

3. The reverse data rate control method of claim 1, wherein the application range indication information includes ALL_ACID_IND information indicating whether the grant message is applied to entire ARQ-channels and PERSISTENCE information indicating whether the grant message keeps being applied to a specific ARQ-channel.

4. The reverse data rate control method of claim 1, wherein the prescribed range is an ARQ-channel unit group.

5. The reverse data rate control method of claim 2, wherein the reverse data rate is determined within a range of authorized_TPR corresponding to the maximum encoder packet size (EP-SIE) included in the grant message.

6. The reverse data rate control method of claim 3, wherein if values of the ALL_ACID_IND and the PERSISTENCE are TRUE and FALSE, respectively, the contents of the grant message are applied within the ARQ-channel unit group.

7. The reverse data rate control method of claim 3, wherein if each value of the ALL_ACID_IND and the PERSISTENCE is FALSE, respectively, the contents of the grant message are applied to a corresponding ARQ-channel within the ARQ-channel unit group only.

8. The reverse data rate control method of claim 1, wherein a channel carrying reverse data is a reverse-packet data channel (R-PDCH).

9. The reverse data rate control method of claim 1, wherein the grant message is received over a forward-grant channel (F-GCH).
